(19) United States
(12) Patent Application Publication
(10) Pub. No.: US 2015/0304137 A1
(43) Pub. Date: Oct. 22, 2015

(54) TRANSMISSION GATE FOR BIAS VOLTAGE GENERATION

(71) Applicant: QUALCOMM Incorporated, San Diego, CA (US)

(72) Inventors: Meysam Azin, San Diego, CA (US); Wenchang Huang, San Diego, CA (US); Le Wang, San Diego, CA (US)

(73) Assignee: QUALCOMM Incorporated, San Diego, CA (US)

(21) Appl. No.: 14/257,425

(22) Filed: Apr. 21, 2014

(51) Int. Cl. H04L 25/08; H04L 27/04

(52) U.S. Cl. CPC H04L 25/08; H04L 27/04

(57) ABSTRACT

An apparatus includes a transmission gate configured to generate a signal based on a first differential input signal and a second differential input signal. The apparatus further includes biasing circuitry responsive to the transmission gate and configured to output a bias voltage based on the signal.

### I. FIELD

The present disclosure is generally related to a transmission gate for bias voltage generation.

### II. DESCRIPTION OF RELATED ART

Advances in technology have resulted in smaller and more powerful computing devices. For example, there currently exist a variety of portable personal computing devices, including wireless computing devices, such as portable wireless telephones, personal digital assistants (PDAs), and paging devices that are small, lightweight, and easily carried by users. More specifically, portable wireless telephones, such as cellular telephones and Internet protocol (IP) telephones, can communicate voice and data packets over wireless networks. Further, many such wireless telephones include other types of devices that are incorporated therein. For example, a wireless telephone can also include a digital still camera, a digital video camera, a digital recorder, and an audio file player. Also, such wireless telephones can process executable instructions, including software applications, such as a web browser application, that can be used to access the Internet. As such, these wireless telephones can include significant computing capabilities.

Wireless telephones may include microphones configured to capture audio signals. A capacitive programmable gain amplifier (PGA) may be used to amplify a signal, such as a microphone signal (e.g., the audio signal). The capacitive PGA may include an input capacitor coupled to a common mode input of an operational amplifier (e.g., virtual ground) and multiple feedback capacitors coupled to corresponding feedback paths of the operational amplifier. A feedback resistor having a relatively high resistance may be coupled in parallel with the feedback capacitors to set the common mode input and to achieve a low cut off frequency to reduce attenuation of the audio signal. Each feedback capacitor may be selectively coupled to or decoupled from the common mode input using corresponding switching circuitry to control the gain of the capacitive PGA. However, leakage current (e.g., reverse bias junction leakage current) from the switches may flow through the feedback resistor and cause a relatively large common mode shift (e.g., drift) at the common mode input. The drift at the common mode input may cause distortion for single-ended signals. For example, a voltage swing may occur at virtual ground for single-ended signals. The common mode shift in addition to the voltage swing may cause input transistors of the operational amplifier to operate in a linear region, which may cause distortion.

### III. BRIEF DESCRIPTION OF THE DRAWINGS

FIG. 1 shows a wireless device communicating with a wireless system;

FIG. 2 shows a block diagram of the wireless device in FIG. 1;

FIG. 3 is a diagram that depicts an exemplary embodiment of a system that is operable to reduce leakage current of a gain switch of a programmable capacitive gain amplifier;

FIG. 4 is a circuit diagram that depicts an exemplary embodiment of components of an operational amplifier and components of biasing circuitry according to a p-type metal oxide semiconductor (PMOS) transistor configuration;

FIG. 5 is a circuit diagram that depicts an exemplary embodiment of components of an operational amplifier and components of biasing circuitry according to an n-type metal oxide semiconductor (NMOS) transistor configuration;

FIG. 6 is a circuit diagram that depicts an exemplary embodiment of a gain switch for a capacitive programmable gain amplifier; and

FIG. 7 is a flowchart that illustrates an exemplary embodiment of a method for reducing junction leakage current for a capacitive programmable gain amplifier.

### IV. DETAILED DESCRIPTION

The detailed description set forth below is intended as a description of exemplary designs of the present disclosure and is not intended to represent the only designs in which the present disclosure can be practiced. The term “exemplary” is used herein to mean “serving as an example, instance, or illustration.” Any design described herein as “exemplary” is not necessarily to be construed as preferred or advantageous over other designs. The detailed description includes specific details for the purpose of providing a thorough understanding of the exemplary designs of the present disclosure. It will be apparent to those skilled in the art that the exemplary designs described herein may be practiced without these specific details. In some instances, well-known structures and devices are shown in block diagram form in order to avoid obscuring the novelty of the exemplary designs presented herein.

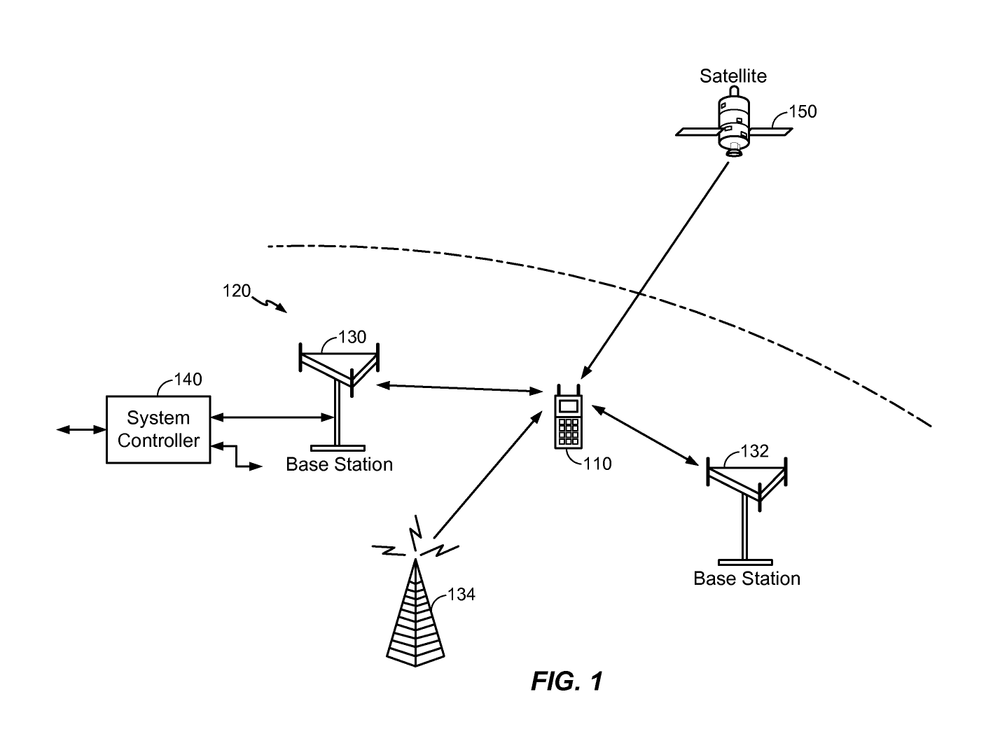

FIG. 1 shows a wireless device 110 communicating with a wireless communication system 120. Wireless communication system 120 may be a Long Term Evolution (LTE) system, a Code Division Multiple Access (CDMA) system, a Global System for Mobile Communications (GSM) system, a wireless local area network (WLAN) system, or some other wireless system. A CDMA system may implement Wideband CDMA (WCDMA), CDMA 1X, Evolution-Data Optimized (EVDO), Time Division Synchronous CDMA (TD-SCDMA), or some other version of CDMA. For simplicity, FIG. 1 shows wireless communication system 120 including two base stations 130 and 132 and one system controller 140. In general, a wireless system may include any number of base stations and any set of network entities.

Wireless device 110 may also be referred to as a user equipment (UE), a mobile station, a terminal, an access terminal, a subscriber unit, a station, etc. Wireless device 110 may be a cellular phone, a smartphone, a tablet, a wireless modem, a personal digital assistant (PDA), a handheld device, a laptop computer, a smartbook, a netbook, a cordless phone, a wireless local loop (WLL) station, a Bluetooth device, etc. Wireless device 110 may communicate with wireless system 120. Wireless device 110 may also receive signals from broadcast stations (e.g., a broadcast station 134), signals from satellites (e.g., a satellite 150) in one or more global navigation satellite systems (GNSS), etc. Wireless device 110 may support one or more radio technologies for wireless communication such as LTE, WCDMA, CDMA 1X, EVDO, TD-SCDMA, GSM, 802.11, etc.

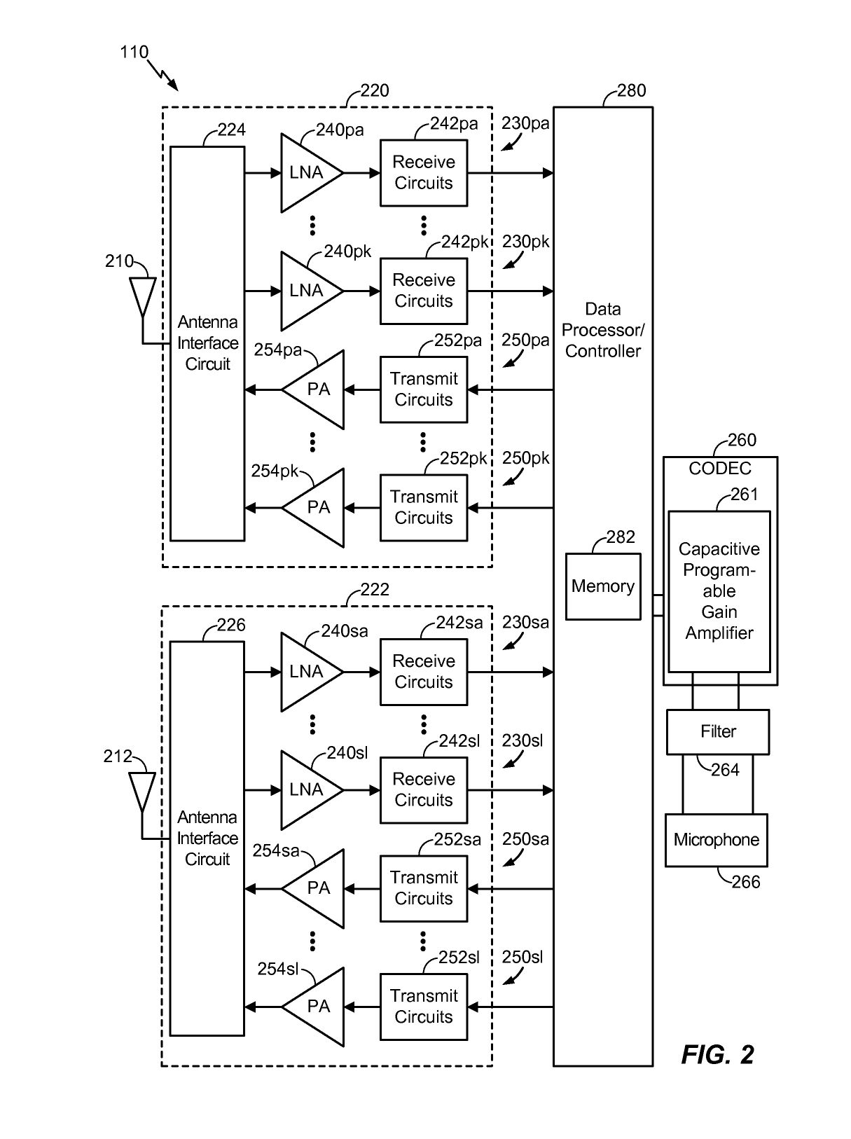

FIG. 2 shows a block diagram of an exemplary design of wireless device 110 in FIG. 1. In this exemplary design, wireless device 110 includes a transceiver 220 coupled to a primary antenna 210, a transceiver 222 coupled to a secondary antenna 212, and a data processor/controller 280. Transceiver 220 includes multiple (K) receivers 230pa to 230pk and multiple (K) transmitters 250pa to 250pk to support multiple frequency bands, multiple radio technologies, carrier aggregation, etc. Transceiver 222 includes multiple (L) receivers 230sa to 230sl and multiple (L) transmitters 250sa to 250sl to support multiple frequency bands, multiple radio technologies, carrier aggregation, receive diversity, multiple-input multiple-output (MIMO) transmission from multiple transmit antennas to multiple receive antennas, etc.

In the exemplary design shown in FIG. 2, each receiver 230 includes an LNA 240 and receive circuits 242. For data reception, antenna 210 receives signals from base stations and/or other transmitter stations and provides a received RF signal, which is routed through an antenna interface circuit 224 and presented as an input RF signal to a selected receiver. Antenna interface circuit 224 may include switches, duplexers, transmit filters, receive filters, matching circuits, etc. The description below assumes that receiver 230pa is the selected receiver. Within receiver 230pa, an LNA 240pa amplifies the input RF signal and provides an output RF signal. Receive circuits 242pa downconvert the output RF signal from RF to baseband, amplify and filter the downconverted signal, and provide an analog input signal to data processor 280. Receive circuits 242pa may include mixers, filters, amplifiers, matching circuits, an oscillator, a local oscillator (LO) generator, a phase locked loop (PLL), etc. Each remaining receiver 230 in transceivers 220 and 222 may operate in similar manner as receiver 230pa.

In the exemplary design shown in FIG. 2, each transmitter 250 includes transmit circuits 252 and a power amplifier (PA) 254. For data transmission, data processor 280 processes (e.g., encodes and modulates) data to be transmitted and provides an analog output signal to a selected transmitter. The description below assumes that transmitter 250pa is the selected transmitter. Within transmitter 250pa, transmit circuits 252pa amplify, filter, and upconvert the analog output signal from baseband to RF and provide a modulated RF signal. Transmit circuits 252pa may include amplifiers, filters, mixers, matching circuits, an oscillator, an LO generator, a PLL, etc. A PA 254pa receives and amplifies the modulated RF signal and provides a transmit RF signal having the proper output power level. The transmit RF signal is routed through antenna interface circuit 224 and transmitted via antenna 210. Each remaining transmitter 250 in transceivers 220 and 222 may operate in similar manner as transmitter 250pa.

FIG. 2 shows an exemplary design of receiver 230 and transmitter 250. A receiver and a transmitter may also include other circuits not shown in FIG. 2, such as filters, matching circuits, etc. All or a portion of transceivers 220 and 222 may be implemented on one or more analog integrated circuits (ICs), RF ICs (RFICs), mixed-signal ICs, etc. For example, LNAs 240 and receive circuits 242 may be implemented on one module, which may be an RFIC, etc. The circuits in transceivers 220 and 222 may also be implemented in other manners.

Data processor/controller 280 may perform various functions for wireless device 110. For example, data processor 280 may perform processing for data being received via receivers 230 and data being transmitted via transmitters 250. Controller 280 may control the operation of the various circuits within transceivers 220 and 222. A memory 282 may store program codes and data for data processor/controller 280. Data processor/controller 280 may be implemented on one or more application specific integrated circuits (ASICs) and/or other ICs.

A coder/decoder (CODEC) 260 may be coupled to the data processor 280. The CODEC 260 may include a capacitive programmable gain amplifier 261. The capacitive programmable gain amplifier 261 is integrated into the CODEC 260 and is operable to adjust a magnitude of audio signals (e.g., amplify audio signals) at the wireless device 110. For example, the capacitive programmable gain amplifier 261 may amplify audio speech signals received by the wireless device 110 via a microphone 266. In an exemplary embodiment, the audio signals captured by the microphone 266 may be filtered by a filter 264, and the filtered audio signals are amplified by the capacitive programmable gain amplifier 261.

Wireless device 110 may support multiple band groups, multiple radio technologies, and/or multiple antennas. Wireless device 110 may include a number of LNAs to support reception via the multiple band groups, multiple radio technologies, and/or multiple antennas.

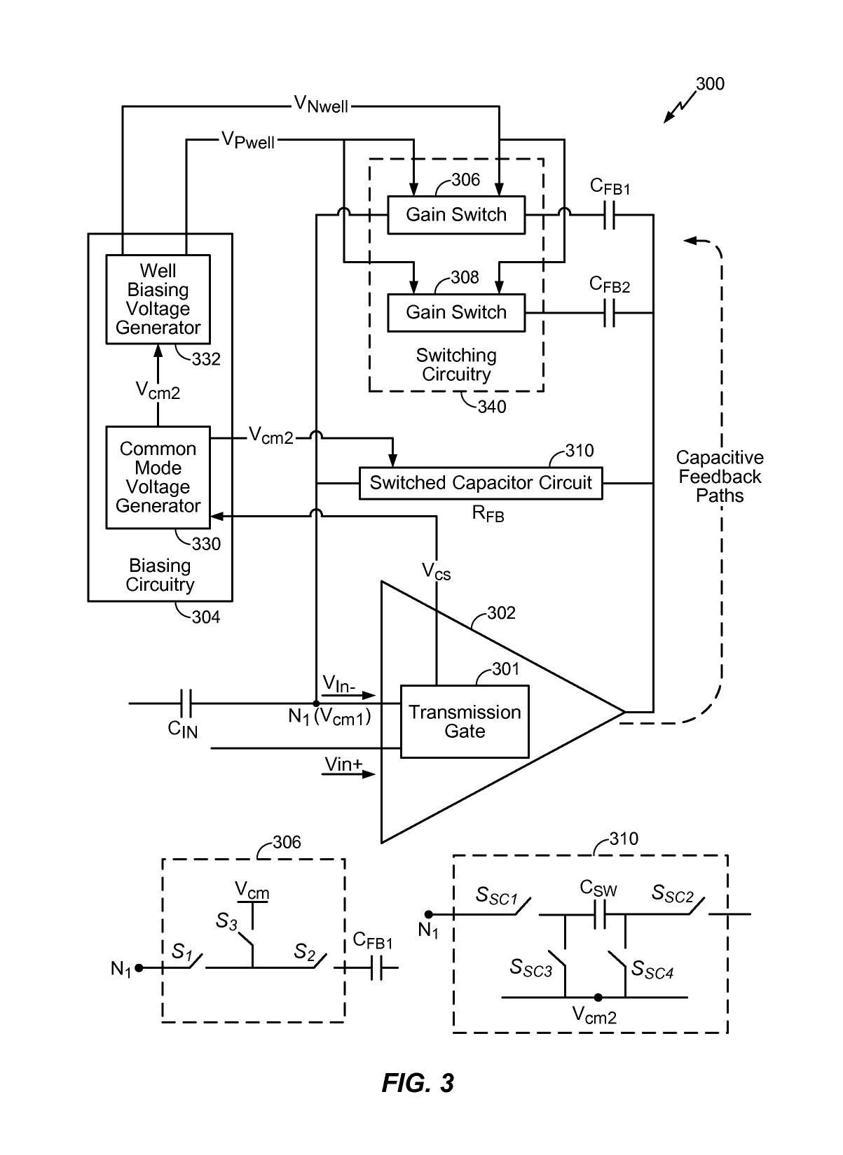

Referring to FIG. 3, a diagram of a system 300 that is operable to reduce leakage current of a gain switch of a capacitive programmable gain amplifier is shown. In an exemplary embodiment, the system 300 may correspond to a capacitive programmable gain amplifier, such as the capacitive programmable gain amplifier 261 of FIG. 2. For example, the system 300 may be operable to amplify audio signals captured by the microphone 266 of the wireless device 110 of FIG. 2. The system 300 includes an operational amplifier 302, biasing circuitry 304, switching circuitry 340 (e.g., a first gain switch 306 and a second gain switch 308), and a switched capacitor circuit 310.

An input capacitor (C_{IN}) may be coupled in series to a common mode input (e.g., a first node (N₁)) of the operational amplifier 302. Although the input capacitor (C_{IN}) is depicted as a single capacitor, in other exemplary embodiments, the input capacitor (C_{IN}) may correspond to an array of capacitors that are selectively coupled and decoupled to the common mode input.

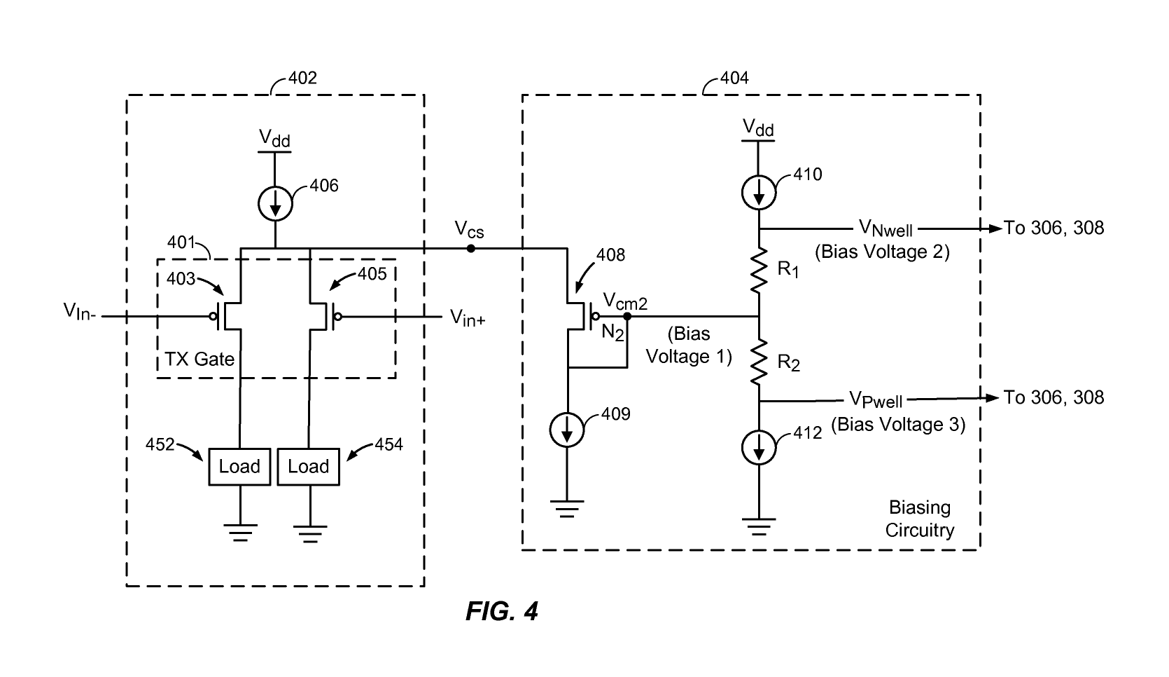

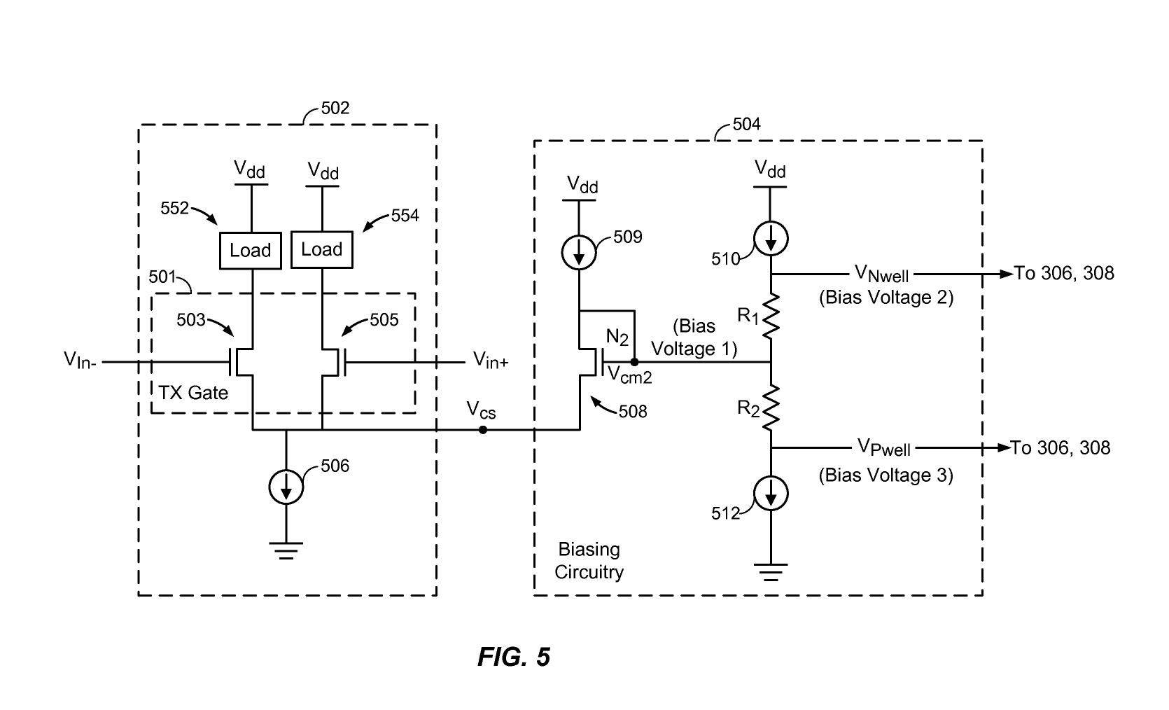

The operational amplifier 302 may include a transmission gate 301 (e.g., a low voltage transmission gate). As described in further detail with respect to FIGS. 4-5, the transmission gate 301 may include a pair of transistors coupled to receive a first differential input signal (Vin−) and a second differential input signal (Vin+). As illustrated in FIG. 3, the differential input signals (Vin−, Vin+) may be received at the common mode inputs of the operational amplifier 302. For example, a voltage level of the first differential input signal (Vin−) may be approximately equal to the common mode voltage (V_{cm1}) at the first node (N₁), and a voltage level of the second differential input signal (Vin+) may be approximately equal to the common mode voltage at a second common mode input of the operational amplifier 302. As used herein, the voltage level of the differential input signals (Vin−, Vin+) and the common mode voltage (V_{cm1}) may be used interchangeably.

An output of the operational amplifier 302 is coupled to three feedback paths coupled together in parallel. For example, the three feedback paths include a resistive feedback path (e.g., a direct-current feedback path) that includes the switched capacitor circuit 310, a first capacitive feedback path that includes the first gain switch 306 and a first feedback capacitor (C_{FB1}), and a second capacitive feedback path that includes the second gain switch 308 and a second feedback capacitor (C_{FB2}). Although two capacitive feedback paths are illustrated, in other exemplary embodiments, the system 300 may include additional capacitive feedback paths that include gain switches and feedback capacitors. Each gain switch 306, 308 may selectively couple and decouple the feedback capacitors (C_{FB1}, C_{FB2}) to the common mode input of the operational amplifier 302. For example, the first gain switch 306 may selectively couple and decouple the first feedback capacitor (C_{FB1}) to the common mode input, and the second gain switch 308 may selectively couple and decouple the second feedback capacitor (C_{FB2}) to the common mode input.

The gain of the programmable gain amplifier (e.g., the gain of the system 300) is based on the input capacitance (C_{IN}) and the feedback capacitance (C_{FB1}, C_{FB2}). For example, the gain is equal to the input capacitance divided by the feedback capacitance.

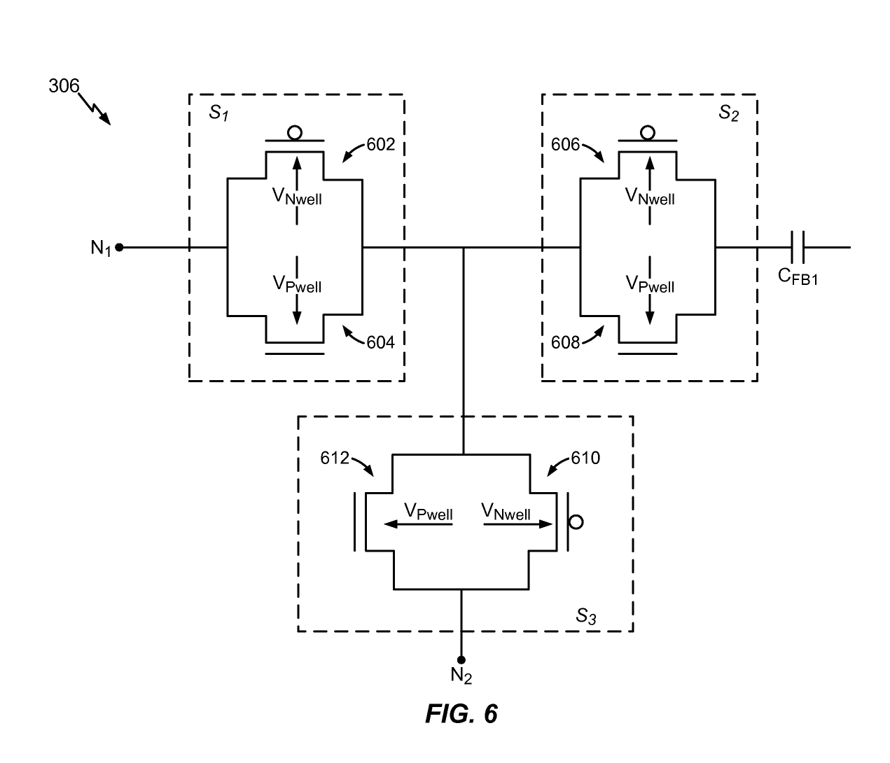

The first gain switch 306 may include a first transmission gate (S₁), a second transmission gate (S₂), and a third transmission gate (S₃). As explained in greater detail with respect to FIG. 6, each transmission gate (S₁-S₃) may include an n-type metal oxide semiconductor (NMOS) transistor having a p-type well and a p-type metal oxide semiconductor (PMOS) transistor having an n-type well. The wells of the transistors may be biased by the biasing circuitry 304 to reduce junction leakage current of the transistors, as described below. The second gain switch 308, and any additional gain switches that are associated with other capacitive feedback paths, may have a similar configuration as the first gain switch 306. For example, each gain switch 306, 308 of the system 300 may include transistors having wells that are biased by the biasing circuitry 304 to reduce junction leakage current. Although, the first gain switch 306 is illustrated as a T-Switch, in other exemplary embodiments, different gain switch configurations may be utilized. For example, the first gain switch 306 and the second gain switch 308 may be implemented in other configurations to selectively couple the first feedback capacitor (C_{FB1}) and the second feedback capacitor (C_{FB2}), respectively, to the first node (N₁).

The switched capacitor circuit 310 may be configured to generate an effective resistance (R_{FB}) that is relatively large (e.g., greater than 32 Giga-ohms) to reduce attenuation of an input audio signal. For example, the switched capacitor circuit 310 may include a capacitor (C_{SW}) and a plurality of switches (S_{SC1}-S_{SC4}). The effective resistance (R_{FB}) of the switched capacitor circuit 310 may be controlled by selectively enabling and disabling the switches (S_{SC1}-S_{SC4}) coupled to the capacitor (C_{SW}) to control (e.g., limit) an amount of current flow to the common mode input (e.g., the first node (N₁)) via the resistive feedback path.

The biasing circuitry 304 may be configured to generate a p-type well biasing voltage (V_{Pwell}) and an n-type well biasing voltage (V_{Nwell}) that is based at least in part on the common mode voltage (V_{cm1}) (e.g., the voltage at the first node (N₁)). To illustrate, the operational amplifier 302 may provide a common source voltage (V_{cs}) to a common mode voltage generator 330 of the biasing circuitry 304. As described in greater detail with respect to FIGS. 4-5, a pair of common mode input voltages may be applied to gates of transistors in the operational amplifier 302 having a common source. The common source may be coupled to the biasing circuitry 304 such that the common source voltage (V_{cs}) of the transistors is provided to the biasing circuitry 304. In other exemplary embodiments, the common source voltage (V_{cs}) may be generated using an additional differential pair that consumes additional power and die area. Although the exemplary embodiment depicted in FIG. 3 depicts that the common source voltage (V_{cs}) is provided to the biasing circuitry 304, in other exemplary embodiments, a different voltage may be provided to the biasing circuitry 304.

Based on the common source voltage (V_{cs}), the common mode voltage generator 330 may generate a common mode voltage (V_{cm2}) (e.g., may regenerate the common mode voltage (V_{cm1}) at the first node (N₁)) by summing the common source voltage (V_{cs}) with a gate-to-source voltage of a transistor in the biasing circuitry 304, as described with respect to FIGS. 4-5. The common mode voltage generator 330 may provide the generated common mode voltage (V_{cm2}) to the switched capacitor circuit 310. In one exemplary embodiment, the common mode voltage generator 330 may provide the common mode voltage (V_{cm2}) to a well biasing voltage generator 332, and the well biasing voltage generator 332 may be configured to add a first offset voltage to the common mode voltage (V_{cm2}) to generate the n-type well biasing voltage (V_{Nwell}). Adding the first offset voltage to the common mode voltage (V_{cm2}) may reduce or prevent leakage current of PMOS transistors in the gain switches and may prevent forward-bias mode enablement of PMOS transistors in the gain switches 306, 308. In another exemplary embodiment, the common mode voltage (V_{cm2}) may be the n-type well biasing voltage (V_{Nwell}). For example, the common mode voltage (V_{cm2}) may be directly applied to the switching circuitry 340 (without being offset by the first offset voltage).

In another exemplary embodiment, the common mode voltage generator 330 may provide the common mode voltage (V_{cm2}) to the well biasing voltage generator 332, and the well biasing voltage generator 332 may be configured to “subtract” a second offset voltage from the common mode voltage (V_{cm2}) to generate the p-type well biasing voltage (V_{Pwell}). Subtracting the second offset voltage from the common mode voltage (V_{cm2}) may reduce or prevent leakage current of NMOS transistors in the gain switches and may prevent forward-bias mode enablement of NMOS transistors in the gain switches 306, 308. In another exemplary embodiment, the common mode voltage (V_{cm2}) may be the p-type well biasing voltage (V_{Pwell}). For example, the common mode voltage (V_{cm2}) may be directly applied to the switching circuitry 340 (without being offset by the second offset voltage).

The system 300 of FIG. 3 may enable well biasing of transistors in the gain switches 306, 308 to prevent junction current leakage (or to reduce junction leakage) from propagating to the first node (N₁). By providing the biasing voltages (V_{Nwell}, V_{Pwell}) to the gain switches 306, 308, the biasing circuitry 304 may reduce the junction leakage of transistors in the gain switches 306, 308. Reducing the junction leakage of the transistors may reduce a common mode shift at virtual ground (e.g., the first node (N₁)). For example, reducing the junction leakage current may substantially prohibit junction leakage current from propagating to virtual ground. As a result, virtual ground may not be subject to both common mode shifts and voltage swings caused by single-ended signals (e.g., single-ended outputs of the operational amplifier 302) which may cause the transistors in the operational amplifier 302 to operate in a linear region. In turn, distortion at the operational amplifier 302 is reduced.

Referring to FIG. 4, a circuit diagram showing components of an operational amplifier 402 and components of biasing circuitry 404 is shown. The operational amplifier 402 may correspond to the operational amplifier 302 of FIG. 3 and may operate in a substantially similar manner, and the biasing circuitry 404 may correspond to the biasing circuitry 304 of FIG. 3 and may operate in a substantially similar manner. For example, the circuit diagram of FIG. 4 depicts a PMOS configuration of the operational amplifier 302 and the biasing circuitry 304.

The operational amplifier 402 includes a transmission (TX) gate 401 (e.g., a low voltage transmission gate). The transmission gate 401 may correspond to the transmission gate 301 of FIG. 3. The transmission gate 401 includes a first transistor 403 and a second transistor 405. In an exemplary embodiment, the first transistor 403 and the second transistor 405 are PMOS transistors. A gate of the first transistor 403 is coupled to receive a first common mode input voltage (Vin−), and a gate of the second transistor 405 is coupled to receive a second common mode input voltage (Vin+). In an exemplary embodiment, the first common mode input voltage (Vin−) is equal to the voltage at the common mode input (e.g., the voltage of the first node (N₁)). A drain of the first transistor 403 and a drain of the second transistor 405 may be coupled to ground via a first load 452 and a second load 454, respectively. In an exemplary embodiment, the first load 452 and the second load 454 may be resistive loads. In another exemplary embodiment, the first load 452 and the second load 454 may be active loads. The first transistor 403 and the second transistor 405 may correspond to a first stage of the operational amplifier 402. A source of the first transistor 403 may be coupled to a source of the second transistor 405 (e.g., the first and second transistors 403, 405 are common source transistors).

A first current source 406 may be coupled to a supply voltage (V_{dd}) and coupled to provide a current to the source terminals of the first and second transistors 403, 405. In an exemplary embodiment, the first current source 406 may be implemented via cascaded transistors that are selectively activated and deactivated to adjust an amount of current provided to the source terminals of the first and second transistors 403, 405. A voltage at the source terminals of the first and second transistors 403, 405 (e.g., the common source voltage (V_{cs})) may be provided to the biasing circuitry 404. In another exemplary embodiment, the common source voltage (V_{cs}) may be generated using an additional differential pair (used in parallel with the main input differential pair) that consumes additional power and die area. Although the exemplary embodiment depicted in FIG. 4 depicts that the common source voltage (V_{cs}) is provided to the biasing circuitry 404, in other exemplary embodiments, a different voltage may be provided to the biasing circuitry 404.

The biasing circuitry 404 includes a third transistor 408 and a second current source 409. In an exemplary embodiment, the third transistor 408 is a PMOS transistor. A source of the third transistor 408 may be coupled to receive the common source voltage (V_{cs}) from the operational amplifier 402. A drain of the third transistor 408 may be coupled to the second current source 409 and to a gate of the third transistor 408 at a second node (N₂). In an exemplary embodiment, the second current source 409 may be implemented via cascaded transistors that are selectively activated and deactivated to adjust an amount of current propagating through the third transistor 408.

The biasing circuitry 404 may be configured to track the common mode input voltage (Vin−, Vin+) of the operational amplifier 402. For example, a gate-to-source voltage of the third transistor 408 may be summed with the common source voltage (V_{cs}) to generate the common mode voltage (V_{cm2}) at the second node (N₂) (e.g., at the gate of the third transistor 408). The common mode voltage (V_{cm2}) may approximate the common mode input voltages (Vin−, Vin+). For example, proportionalities between transistors sizes (e.g., the size of the transistors 403, 405 in the operational amplifier 402 and the size of the third transistor 408) and currents from the current sources 406, 409 may be selected such that the common mode voltage (V_{cm}) is substantially equal to the common mode input voltages (e.g., Vin−, Vin+) (e.g., the voltages at the gates of the transistors 403, 405 in the operational amplifier 402 are substantially equal to the voltage at the gate of the third transistor 408).

As an illustrative non-limiting example, the third transistor 408 may be approximately one-eighteenth the size of the transistors 403, 405 in the operational amplifier 402. Based on this ratio, the current generated by the first current source 406 may be approximately seventeen times greater than the current generated by the second current source 409 so that the common mode voltage (V_{cm2}) is substantially equal to the common mode input voltages (Vin−, Vin+). For example, the current ratio compensates for variances in transistor size, which may correspond to variances in voltages across the transistors. To illustrate, the first current source 406 may generate a 34 micro-ampere current and the second current source 409 may generate a 2 micro-ampere current.

The ratio of the currents flowing through the current sources 406, 409 may change based on changes in the size aspect ratio of the transistors 403, 405, 408. For example, if the third transistor 408 is one-ninth the size of the transistors 403, 405 in the operational amplifier 402, the first current source 406 generates a current that is approximately nineteen times greater than the current generated by the second current source 409 so that the common mode voltage (V_{cm2}) is substantially equal to the common mode input voltages (Vin−, Vin+). The current ratio compensates for variances in transistor size, which may correspond to variances in voltages across the transistors. To illustrate, the first current source 406 may generate a 76 micro-ampere current and the second current source 409 may generate a 4 micro-ampere current.

The biasing circuitry 404 may also include a voltage level shifter circuit. The voltage level shifter circuit may include a third current source 410, a fourth current source 412, a first resistor (R₁), and a second resistor (R₂). The third current source 410 may be coupled to the supply voltage (V_{dd}) and to a first terminal of the first resistor (R₁). The third current source 410 may be implemented via cascaded transistors that are selectively activated and deactivated to adjust an amount of current provided to the first resistor (R₁). The common mode voltage (V_{cm2}) may be coupled to a second terminal of the first resistor (R₁). The fourth current source 412 may be coupled to ground and to a first terminal of the second resistor (R₂). The fourth current source may be implemented via cascaded transistors that are selectively activated and deactivated to adjust an amount of current provided to the second resistor (R₂). In an exemplary embodiment, the current generated by the third current source 410 may be substantially equal to the current generated by the fourth current source 412. The common mode voltage (V_{cm2}) may be coupled to a second terminal of the second resistor (R₂).

The biasing circuitry 404 may be configured to add a first offset voltage (e.g., the voltage across the first resistor (R₁)) to the common mode voltage (V_{cm}) to generate the n-type well biasing voltage (V_{Nwell}). The first offset voltage may be approximately equal to the resistance of first resistor (R₁) multiplied by the current generated by the third current source 410. Adding the first offset voltage to the common mode voltage (V_{cm}) to generate the n-type well biasing voltage (V_{Nwell}) may reduce (or prevent) forward biasing of PMOS transistors in the gain switches 306, 308 that may be attributed to transistors mismatch (403, 405 and 408) (e.g., swings at the first node (N₁)).

Additionally, the biasing circuitry 404 may be configured to “subtract” a second offset voltage (e.g., the voltage across the second resistor (R₂) from the common mode voltage (V₂) to generate the p-type well biasing voltage (V_{Pwell}). The second biasing voltage may be approximately equal to the resistance of the second resistor (R₂) multiplied by the current generated by the fourth current source 412. Subtracting the second offset voltage from the common mode voltage (V_{cm2}) to generate the p-type well biasing voltage (V_{Pwell}) may reduce (or prevent) forward biasing of NMOS transistors in the gain switches 306, 308 that may be attributed to transistor mismatch.

In an exemplary embodiment, the first offset voltage and the second offset voltage are substantially equal. For example, the resistance of the first resistor (R₁) may be substantially equal to the resistance of the second resistor (R₂). As an illustrative example, the first offset voltage and the second offset voltage may be approximately 50 milli-volts. In another exemplary embodiment, the first offset voltage and the second offset voltage may differ when NMOS transistors and PMOS transistors in the gain switches 306, 308 have different characteristics (e.g., size, threshold voltages, etc.). For example, the resistance of the first resistor (R₁) may be different from the resistance of the second resistor (R₂). The resistances may vary based on design implementation.

The biasing circuitry 404 may provide the n-type well biasing voltage (V_{Nwell}) to well terminals of PMOS transistors in the gain switches 306, 308 to reduce (or prevent) junction leakage of the PMOS transistors. Additionally, the biasing circuitry 404 may provide the p-type well biasing voltage (V_{Pwell}) to well terminals of NMOS transistors in the gain switches 306, 308 to reduce (or prevent) junction leakage current of the NMOS transistors.

By providing the biasing voltages (V_{Nwell}, V_{Pwell}) to the gain switches 306, 308, the biasing circuitry 404 may reduce the junction leakage of transistors in the gain switches 306, 308. Reducing the junction leakage of the transistors may reduce common mode shift at the common mode input (e.g., virtual ground). For example, reducing the junction leakage current may be substantially prohibited junction leakage current from propagating to the common mode input. As a result, the common mode input may not be subject to both common mode shifts and voltage swings caused by single-ended signals (e.g., single-ended outputs of the operational amplifier 402) which may cause the transistors 403, 405 to operate in linear region. In turn, distortion at the operational amplifier 402 is reduced.

Referring to FIG. 5, a circuit diagram showing components of an operational amplifier 502 and components of biasing circuitry 504 is shown. The operational amplifier 502 may correspond to the operational amplifier 302 of FIG. 3 and may operate in a substantially similar manner, and the biasing circuitry 504 may correspond to the biasing circuitry 304 of FIG. 3 and may operate in a substantially similar manner. For example, the circuit diagram of FIG. 5 depicts an NMOS configuration of the operational amplifier 302 and the biasing circuitry 304. The circuit of FIG. 5 is an alternative embodiment to the circuit of FIG. 4.

The operational amplifier 502 includes a transmission (TX) gate 501 (e.g., a low voltage transmission gate). The transmission gate 501 may correspond to the transmission gate 301 of FIG. 3. The transmission gate 501 includes a first transistor 503 and a second transistor 505. In an exemplary embodiment, the first transistor 503 and the second transistor 505 are NMOS transistors. A gate of the first transistor 503 is coupled to receive a first common mode input voltage (Vin−), and a gate of the second transistor 505 is coupled to receive a second common mode input voltage (Vin+). In an exemplary embodiment, the first common mode input voltage (Vin−) is equal to the voltage at the common mode input (e.g., the voltage of the first node (N₁)). A drain of the first transistor 503 and a drain of the second transistor 505 may be coupled to a supply voltage (V_{dd}) via a first load 552 and a second load 554, respectively. In an exemplary embodiment, the first load 552 and the second load 554 may be resistive loads. In another exemplary embodiment, the first load 552 and the second load 554 may be active loads. The first transistor 503 and the second transistor 505 may correspond to a first stage of the operational amplifier 502. A source of the first transistor 503 may be coupled to a source of the second transistor 505 (e.g., the first and second transistors 503, 505 are common source transistors).

A first current source 506 may be coupled to ground and coupled to source a current to the source terminals of the first and second transistors 503, 505. In an exemplary embodiment, the first current source 506 may be implemented via cascaded transistors that are selectively activated and deactivated to adjust an amount of current provided to the source terminals of the first and second transistors 503, 505. A voltage at the source terminals of the first and second transistors 503, 505 (e.g., the common source voltage (V_{cs})) may be provided to the biasing circuitry 504. In another exemplary embodiment, the common source voltage (V_{cs}) may be generated using an additional differential pair (used in parallel with the main input differential pair) that consumes additional power and die area. Although the exemplary embodiment depicted in FIG. 5 depicts that the common source voltage (V_{cs}) is provided to the biasing circuitry 504, in other exemplary embodiments, a different voltage may be provided to the biasing circuitry 504.

The biasing circuitry 504 includes a third transistor 508 and a second current source 509. In an exemplary embodiment, the third transistor 508 is NMOS transistor. A source of the third transistor 508 may be coupled to receive the common source voltage (V_{cs}) from the operational amplifier 502. A drain of the third transistor 508 may be coupled to the second current source 509 and to a gate of the third transistor 508 at a second node (N₂). In an exemplary embodiment, the second current source 509 may be implemented via cascaded transistors that are selectively activated and deactivated to adjust an amount of current propagating through the third transistor 508.

The biasing circuitry 504 may be configured to track the common mode input voltage (Vin−, Vin+) of the operational amplifier 502. For example, a gate-to-source voltage of the third transistor 508 may be summed with the common source voltage (V_{cs}) to generate the common mode voltage (V_{cm}) at the second node (N₂) (e.g., at the gate of the third transistor 508). The common mode voltage (V_{cm2}) may be approximate to the common mode input voltages (Vin−, Vin+). For example, proportionalities between transistors sizes (e.g., the size of the transistors 503, 505 in the operational amplifier 502 and the size of the third transistor 508) and currents from the current sources 506, 509 may be selected such that the common mode voltage (V_{cm2}) is substantially equal to the common mode input voltages (e.g., Vin−, Vin+) (e.g., the voltages at the gates of the transistors 503, 505 in the operational amplifier 502 are substantially equal to the voltage at the gate of the third transistor 508).

As an illustrative non-limiting example, the third transistor 508 may be approximately one-eighteenth the size of the transistors 503, 505 in the operational amplifier 502. Based on this ratio, the current generated by the first current source 506 may be approximately seventeen times greater than the current generated by the second current source 509 so that the common mode voltage (V_{cm2}) is substantially equal to the common mode input voltages (Vin−, Vin+). The current ratio compensates for variances in transistor size, which may correspond to variances in voltages across the transistors. To illustrate, the first current source 506 may generate a 34 micro-ampere current and the second current source 509 may generate a 2 micro-ampere current.

The ratio of the currents flowing through the current sources 506, 509 may change based on changes in the size aspect ratio of the transistors 503, 505, 508. For example, if the third transistor 508 is one-ninth the size of the transistors 503, 505 in the operational amplifier 502, the first current source 506 generates a current that is approximately nineteen times greater than the current generated by the second current source 509 so that the common mode voltage (V_{cm2}) is substantially equal to the common mode input voltages (Vin−, Vin+). To illustrate, the first current source 506 may generate a 76 micro-ampere current and the second current source 509 may generate a 4 micro-ampere current.

The biasing circuitry 504 may also include a voltage level shifter circuit. The voltage level shifter circuit may include a third current source 510, a fourth current source 512, a first resistor (R₁), and a second resistor (R₂). The third current source 510 may be coupled to the supply voltage (V_{dd}) and to a first terminal of the first resistor (R₁). The third current source 510 may be implemented via cascaded transistors that are selectively activated and deactivated to adjust an amount of current provided to the first resistor (R₁). The common mode voltage (V_{cm2}) may be coupled to a second terminal of the first resistor (R₁). The fourth current source 512 may be coupled to ground and to a first terminal of the second resistor (R₂). The fourth current source may be implemented via cascaded transistors that are selectively activated and deactivated to adjust an amount of current provided to the second resistor (R₂). In an exemplary embodiment, the current generated by the third current source 510 may be substantially equal to the current generated by the fourth current source 512. The common mode voltage (V_{cm2}) may be coupled to a second terminal of the second resistor (R₂).

The biasing circuitry 504 may be configured to add a first offset voltage (e.g., the voltage across the first resistor (R₁)) to the common mode voltage (V_{cm}) to generate the n-type well biasing voltage (V_{Nwell}). The first offset voltage may be approximately equal to the resistance of first resistor (R₁) multiplied by the current generated by the third current source 510. Adding the first offset voltage to the common mode voltage (V_{cm2}) to generate the n-type well biasing voltage (V_{Nwell}) may reduce (or prevent) forward biasing of PMOS transistors in the gain switches 306, 308 that may be attributed transistor mismatch (503, 505 and 508) (e.g., swings at the first node (N₁)).

Additionally, the biasing circuitry 504 may be configured to “subtract” a second offset voltage (e.g., the voltage across the second resistor (R₂) from the common mode voltage (V_{cm2}) to generate the p-type well biasing voltage (V_{Pwell}). The second biasing voltage may be approximately equal to the resistance of the second resistor (R₂) multiplied by the current generated by the fourth current source 512. Subtracting the second offset voltage from the common mode voltage (V_{cm2}) to generate the p-type well biasing voltage (V_{Pwell}) may reduce (or prevent) forward biasing of NMOS transistors in the gain switches 306, 308 that may be attributed to transistor mismatch.

In an exemplary embodiment, the first offset voltage and the second offset voltage are substantially equal. For example, the resistance of the first resistor (R₁) may be substantially equal to the resistance of the second resistor (R₂). As an illustrative example, the first offset voltage and the second offset voltage may be approximately 50 milli-volts. In another exemplary embodiment, the first offset voltage and the second offset voltage may differ when NMOS transistors and PMOS transistors in the gain switches 306, 308 have different characteristics (e.g., size, threshold voltages, etc.). For example, the resistance of the first resistor (R₁) may be different from the resistance of the second resistor (R₂). The resistances may vary based on design implementation.

The biasing circuitry 504 may provide the n-type well biasing voltage (V_{Nwell}) to well terminals of PMOS transistors in the gain switches 306, 308 to reduce (or prevent) junction leakage of the PMOS transistors. Additionally, the biasing circuitry 504 may provide the p-type well biasing voltage (V_{Pwell}) to well terminals of NMOS transistors in the gain switches 306, 308 to reduce (or prevent) junction leakage current of the NMOS transistors.

By providing the biasing voltages (V_{Nwell}, V_{Pwell}) to the gain switches 306, 308, the biasing circuitry 504 may reduce the junction leakage of transistors in the gain switches 306, 308. Reducing the junction leakage of the transistors may reduce common mode shift at the common mode input (e.g., virtual ground). For example, reducing the junction leakage current may be substantially prohibited junction leakage current from propagating to the common mode input. As a result, the common mode input may not be subject to both common mode shifts and voltage swings caused by single-ended signals (e.g., single-ended outputs of the operational amplifier 502) which may cause the transistors 503, 505 to operate in linear region. In turn, distortion at the operational amplifier 502 is reduced.

Referring to FIG. 6, a circuit diagram of the first gain switch 306 is shown. The first gain switch 306 may be coupled to receive the n-type well biasing voltage (V_{Nwell}) and the p-type well biasing voltage (V_{Pwell}) from the biasing circuitry 304, 404, 504 to reduce junction leakage. The first gain switch 306 includes the first transmission gate (S₁), the second transmission gate (S₂), and the third transmission gate (S₃). Although, the first gain switch 306 is illustrated as a T-Switch, in other exemplary embodiments, different gain switch configurations may be utilized. For example, the first gain switch 306 may be implemented in other configurations to selectively couple the first feedback capacitor (C_{FB1}) to the first node (N₁).

The first transmission gate (S₁) includes a first PMOS transistor 602 and a first NMOS transistor 604. A drain of the first PMOS transistor 602 and a drain of the first NMOS transistor 604 are coupled to virtual ground (e.g., the first node (N₁)). A source of the first PMOS transistor 604 and a source of the first NMOS transistor 604 are coupled to the second transmission gate (S₂) and to the third transmission gate (S₃). The biasing circuitry 304, 404, 504 may provide the n-type well biasing voltage (V_{Nwell}) to the well of the first transistor PMOS 602 to reduce junction leakage of the first transistor 602. For example, the n-type well biasing voltage (V_{Nwell}) may reduce a gate-to-body voltage of the first PMOS transistor 602 to reduce (or prevent) junction leakage during a reverse bias mode of operation. Additionally, the biasing circuitry 304. 404, 504 may provide the p-type well biasing voltage (V_{Pwell}) to the well of the first NMOS transistor 604 to reduce junction leakage of the first NMOS transistor 604. For example, the p-type well biasing voltage (V_{Pwell}) may reduce a gate-to-body voltage of the first NMOS transistor 604 to reduce (or prevent) junction leakage during a reverse bias mode of operation.

The second transmission gate (S₂) includes a second PMOS transistor 606 and a second NMOS transistor 608. A source of the second PMOS transistor 606 and a source of the second NMOS transistor 608 are coupled to the first feedback capacitor (C_{FB1}). A drain of the second PMOS transistor 606 and a drain of the second NMOS transistor 608 are coupled to the first transmission gate (S₁) and to the third transmission gate (S₃). The biasing circuitry 304, 404, 504 may provide the n-type well biasing voltage (V_{Nwell}) to the well of the second PMOS transistor 606 to reduce junction leakage of the second PMOS transistor 606. For example, the n-type well biasing voltage (V_{Nwell}) may reduce a gate-to-body voltage of the second PMOS transistor 606 to reduce (or prevent) junction leakage during a reverse bias mode of operation. Additionally, the biasing circuitry 304-504 may provide the p-type well biasing voltage (V_{Pwell}) to the well of the second NMOS transistor 608 to reduce junction leakage of the second NMOS transistor 608. For example, the p-type well biasing voltage (V_{Pwell}) may reduce a gate-to-body voltage of the second NMOS transistor 608 to reduce (or prevent) junction leakage during a reverse bias mode of operation.

The third transmission gate (S₃) includes a third PMOS transistor 610 and a third NMOS transistor 612. The source of the third PMOS transistor 610 and the source of the third NMOS transistor 612 are coupled to the second node (N₂) (e.g., coupled to receive the common mode voltage (V_{cm2})). The drain of the third PMOS transistor 610 and the drain of the third NMOS transistor 612 are coupled to the first transmission gate (S₁) and to the second transmission gate (S₂). The biasing circuitry 304-504 may provide the n-type well biasing voltage (V_{Nwell}) to the well of the third PMOS transistor 610 to reduce junction leakage of the third PMOS transistor 610. For example, the n-type well biasing voltage (V_{Nwell}) may reduce a gate-to-body voltage of the third PMOS transistor 610 to reduce (or prevent) junction leakage during a reverse bias mode of operation. Additionally, the biasing circuitry 304-504 may provide the p-type well biasing voltage (V_{Pwell}) to the well of the third NMOS transistor 612 to reduce junction leakage of the third NMOS transistor 612. For example, the p-type well biasing voltage (V_{Pwell}) may reduce a gate-to-body voltage of the third NMOS transistor 612 to reduce (or prevent) junction leakage during a reverse bias mode of operation.

Providing the biasing voltages (V_{Nwell}, V_{Pwell}) to the wells of the transistors 602-612 may reduce the junction leakage of the transistors 602-612 and may prevent the transistors 602-612 from forward bias operation. Reducing the junction leakage of the transistors 602-612 may reduce the common mode shift at the common mode input (e.g., the drift at the first node (N₁)). For example, reducing the junction leakage current may be substantially prohibited junction leakage current from propagating to the first node (N₁). As a result, the first node (N₁) may not be subject to both common mode shifts and voltage swings caused by single-ended signals (e.g., single-ended outputs of the operational amplifier 302-502) which may cause transistors (e.g., transistors 403, 405, 503, 505) in the operational amplifier 302-502 to operate in linear region. In turn, distortion at the operational amplifier 302-502 may be reduced.

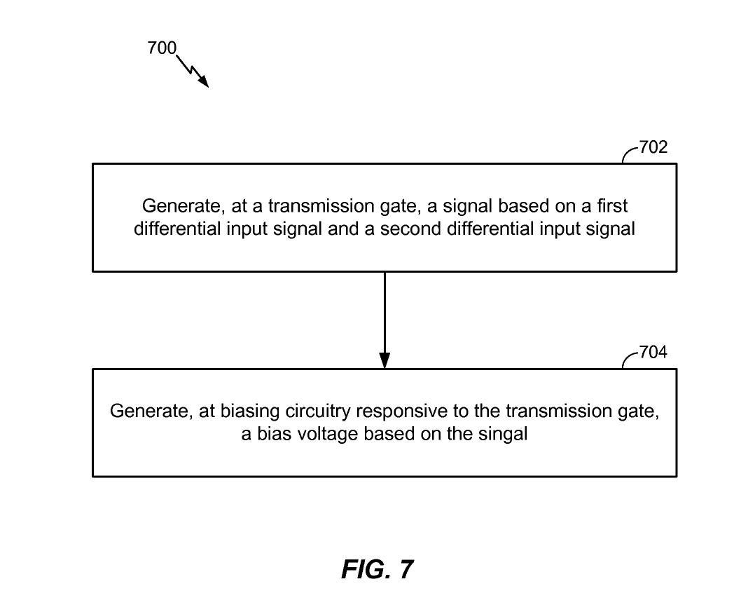

Referring to FIG. 7, a flowchart that illustrates an exemplary embodiment of a method 700 for reducing junction leakage current for a capacitive programmable gain amplifier is shown. In an illustrative embodiment, the method 700 may be performed using the programmable capacitive gain amplifier 261 of the wireless device 110 of FIGS. 1-2, the system 300 of FIG. 3, the operational amplifier 402 and the biasing circuitry 404 of FIG. 4, the operational amplifier 502 and the biasing circuitry 504 of FIG. 5, the first gain switch 306 of FIG. 6, or any combination thereof.

The method 700 includes generating, at a transmission gate, a signal based on a first differential input signal and a second differential input signal, at 702. For example, referring to FIG. 3, the transmission gate 301 includes a pair of transistors coupled to receive the first differential input signal (Vin−) and the second differential input signal (Vin+). The transmission gate 301 may generate a signal (e.g., the common source voltage signal (V_{cs})) based on the first differential input signal (Vin−) and the second differential input signal (Vin+).

A bias voltage may be generated based on the signal at biasing circuitry that is responsive to the transmission gate, at 704. For example, referring to FIG. 3, the biasing circuitry 304 may generate the n-type well biasing voltage (V_{Nwell}) and the p-type well biasing voltage (V_{Pwell}) based on the common source voltage signal (V_{cs}),

In an exemplary embodiment, the method includes tracking, at a node, a common mode input voltage of the transmission gate. For example, referring to FIG. 3, the biasing circuitry 304 may track a voltage at the first node (N₁). To further illustrate, the third transistor 408 of FIG. 4 may be coupled to receive the common source voltage (V_{cs}) from the operational amplifier 402. The gate-to-source voltage of the third transistor 408 may be summed with the common source voltage (V_{cs}) to generate the common mode voltage (V_{cm2}) at the gate of the third transistor 408. The common mode voltage (V_{cm2}) may approximate the common mode input voltages (Vin−, Vin+).

As another example, the third transistor 508 of FIG. 5 may be coupled to receive the common source voltage (V_{cs}) from the operational amplifier 502. The gate-to-source voltage of the third transistor 508 may be summed with the common source voltage (V_{cs}) to generate the common mode voltage (V_{cm2}) at the gate of the third transistor 508. The common mode voltage (V_{cm2}) may approximate the common mode input voltages (Vin−, Vin+).

In an exemplary embodiment, the method 700 may include offsetting the tracked common mode input voltage to generate an offset voltage. For example, referring to FIG. 4, the biasing circuitry 404 may add the first offset voltage (e.g., the voltage across first resistor (R₁)) to the common mode voltage (V_{cm2}) to generate the n-type well biasing voltage (V_{Nwell}), and may “subtract” a second offset voltage (e.g., the voltage across the second resistor (R₂) from the common mode voltage (V_{cm2}) to generate the p-type well biasing voltage (V_{Pwell}). As another example, referring to FIG. 5, the biasing circuitry 504 may add the first offset voltage (e.g., the voltage across first resistor (R₁)) to the common mode voltage (V_{cm2}) to generate the n-type well biasing voltage (V_{Nwell}), and may “subtract” a second offset voltage (e.g., the voltage across the second resistor (R₂) from the common mode voltage (V_{cm2}) to generate the p-type well biasing voltage (V_{Pwell}).

In an exemplary embodiment, the method 700 includes biasing switching circuitry of a capacitive feedback path based on the tracked common mode input voltage. For example, referring to FIG. 6, the n-type well biasing voltage (V_{Nwell}) may be provided to wells of the PMOS transistors 602, 606, 610 of the first gain switch 306 to reduce junction leakage of the PMOS transistors 602, 606, 610. The n-type well biasing voltage (V_{Nwell}) may be based on the tracked common mode voltage (e.g., the common mode voltage (V_{cm2})), as described above. Additionally, the p-type well biasing voltage (V_{Pwell}) may be provided to wells of the NMOS transistors 604, 608, 612 of the first gain switch to reduce junction leakage of the NMOS transistors 604, 608, 612. The p-type well biasing voltage (V_{Pwell}) may be based on the tracked common mode voltage (e.g., the common mode voltage (V_{cm2})), as described above.

The method 700 of FIG. 7 may reduce junction leakage of the transistors to reduce the common mode shift at the common mode input of an operational amplifier (e.g., the operational amplifier 302-502). For example, reducing the junction leakage current may substantially prohibit junction leakage current from propagating to the common mode input. As a result, the common mode input may not be subject to both common mode shifts and voltage swings caused by single-ended signals (e.g., single-ended outputs of the operational amplifier 302-502) which may cause transistors in the operational amplifier 302-502 to operate in a linear region. In turn, distortion at the operational amplifier 302-502 may be reduced.

In conjunction with the described embodiments, an apparatus includes means for generating a transmission gate output signal based on a first differential input signal and a second differential input signal. For example, the means for generating the transmission gate output signal may include the operational amplifier 302 of FIG. 3, the transmission gate 301 of FIG. 3, the transmission gate 401 of FIG. 4 and the components thereof, the operational amplifier 402 of FIG. 4 and the components thereof, the transmission gate 501 of FIG. 5 and the components thereof, the operational amplifier 502 of FIG. 5 and the components thereof, one or more other devices, circuits, modules, or any combination thereof.

The apparatus also includes means for generating a bias voltage based on the transmission gate output signal. The means for generating the bias voltage may be responsive to the means for generating the transmission gate output signal. For example, the means for generating the bias voltage may include the biasing circuitry 304 of FIG. 3 and the components thereof, the biasing circuitry 404 of FIG. 4 and the components thereof, the biasing circuitry 504 of FIG. 5 and the components thereof, one or more other devices, circuits, modules, or any combination thereof.

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. An apparatus comprising:
a transmission gate configured to generate a signal based on a first differential input signal and a second differential input signal; and
biasing circuitry responsive to the transmission gate and configured to output a bias voltage based on the signal.

2. The apparatus of claim 1, wherein the transmission gate comprises:
a first transistor having a gate coupled to receive the first differential input signal; and
a second transistor having a gate coupled to receive the second differential input signal;
wherein a source of the first transistor is coupled to a source of the second transistor.

3. The apparatus of claim 2, wherein the biasing circuitry comprises a third transistor having a source coupled to receive the signal.

4. The apparatus of claim 3, wherein the signal is a common source voltage associated with the source of the first transistor and the source of the second transistor.

5. The apparatus of claim 3, wherein a node at a gate of the third transistor is configured to track a common mode voltage of the transmission gate based on a gate-to-source voltage of the third transistor.

6. The apparatus of claim 5, wherein the biasing circuitry further comprises a voltage level shifter circuit coupled to the node, wherein the voltage level shifter circuit comprises:
a first resistor having a first terminal coupled to the node and a second terminal coupled to a supply voltage via a first current source; and
a second resistor having a first terminal coupled to the node and a second terminal coupled to ground via a second current source.

7. The apparatus of claim 6, wherein the voltage level shifter circuit is configured to generate a second bias voltage from a voltage of the node based on a current generated by the second current source.

8. The apparatus of claim 7, wherein the voltage level shifter circuit is configured to provide the second bias voltage to a well of an n-type metal oxide semiconductor (NMOS) transistor.

9. The apparatus of claim 6, wherein the voltage level shifter circuit is configured to generate a third bias voltage from a voltage at the node based on a current generated by the first current source.

10. The apparatus of claim 9, wherein the voltage level shifter circuit is configured to provide the third bias voltage to a well of a p-type metal oxide semiconductor (PMOS) transistor.

11. The apparatus of claim 1, further comprising at least one transistor, wherein the biasing circuitry is configured to bias a well of the at least one transistor based on the bias voltage.

12. An apparatus comprising:
means for generating a transmission gate output signal based on a first differential input signal and a second differential input signal; and
means for generating a bias voltage based on the transmission gate output signal, the means for generating the bias voltage responsive to the means for generating the transmission gate output signal.

13. The apparatus of claim 11, wherein the means for generating the transmission gate output signal comprises:
means for receiving the first differential input signal; and
means for receiving the second differential input signal;
wherein the means for receiving the first differential input signal is coupled to the means for receiving the second differential input signal.

14. The apparatus of claim 12, wherein the means for generating the bias voltage comprises means for tracking a common mode voltage of the means for generating the transmission gate output signal.

15. The apparatus of claim 14, further comprising means for generating a second bias voltage based on the tracked common mode voltage.

16. The apparatus of claim 14, further comprising means for generating a third bias voltage based on the tracked common mode voltage.

17. The apparatus of claim 12, further comprising at least one transistor, wherein the means for generating the bias voltage is configured to bias a well of the at least one transistor based on the bias voltage.

18. A method comprising:
generating, at a transmission gate, a signal based on a first differential input signal and a second differential input signal; and
generating, at biasing circuitry responsive to the transmission gate, a bias voltage based on the signal.

19. The method of claim 18, further comprising tracking, at a node, a common mode voltage of the transmission gate.

20. The method of claim 18, further comprising biasing a well of a transistor based on the bias voltage.
